(19) United States
(12) Patent Application Publication
(10) Pub. No.: US 2018/0172913 A1
(43) Pub. Date: Jun. 21, 2018

(54) BROADBAND GENERAL INTERFERENCE MMI-BASED POLARIZATION BEAM SPLITTER

(71) Applicant: INPHI CORPORATION, Santa Clara, CA (US)

(72) Inventor: Jie LIN, Santa Clara, CA (US)

(21) Appl. No.: 15/385,686

(22) Filed: Dec. 20, 2016

(51) Int. Cl. G02B 6/27; G02B 6/126; G02B 6/125; G02B 6/122

(52) U.S. Cl. CPC G02B 6/2773; G02B 6/126; G02B 2006/12061; G02B 6/2726; G02B 6/1228; G02B 6/125

(57) ABSTRACT

A polarization beam splitter includes a silicon waveguide body of a thickness in rectangular shape with a width and a length between a first end plane and a second end plane. Two input ports are formed in the first end plane at two separate locations respectively next to two opposing length edges. The silicon waveguide body is configured to generate a plurality of direct or mirror images of an input optical signal provided through at least one of the two input ports. Two output ports are formed in the second end plane, one at a bar-position being configured to output a first output signal substantially in TE polarization mode and another at a cross-position being configured to output a second output signal substantially in TM polarization mode. Preferably, the width is 2.6 μm and the length is 40 μm with the thickness of a silicon layer of a SOI substrate.

### BACKGROUND OF THE INVENTION

The present invention relates to a broadband silicon photonics device. More particularly, the present invention provides a compact general interference Si-based MMI polarization beam splitter with low loss and high extinction ratio for a broad wavelength band of 1530 nm-1560 nm.

Over the last few decades, the use of broadband communication networks exploded. In the early days Internet, popular applications were limited to emails, bulletin board, and mostly informational and text-based web page surfing, and the amount of data transferred was usually relatively small. Today, Internet and mobile applications demand a huge amount of bandwidth for transferring photo, video, music, and other multimedia files. For example, a social network like Facebook processes more than 500 TB of data daily. With such high demands on data and data transfer, existing data communication systems need to be improved to address these needs.

As an important integrated optics device, a compact polarization beam splitter (PBS) can be used to achieve polarization independent operation of photonic integrated circuits (PICs) and linear optical quantum information technology. PBS has become a key element for polarization management in next polarization-independent Si Photonics Circuit. A preferred PBS should simultaneously have short device length, high extinction ratios, low insertion loss, broadband operation, stability, simple structure and high fabrication tolerances. Compact, simple and broadband PBS on silicon-on-insulator (SOI) is crucial for Dense Wavelength Division Multiplexing (DWDM) in the C-band window. The conventional designs for the Si-based PBS are mostly based on two 2×2 MMI devices combined with a Mach-Zehnder interferometer (MZI) device or a directional coupler (DC) device combined with a MZI device. The 2×2 MMI device is polarization insensitive and hard to design. The MZI device requires balanced splitting for Transverse Magnetic (TM) mode which remains at a stage of lab experiment requiring thick (>350 nm) silicon layer or silicon-nitride material not easily workable on standard 220 nm silicon-on-insulator substrate. The DC-based conventional PBS has at least one or more the following issues of long size, bandwidth limited, and poor TE/TM extinction ratio.

Therefore, it is desired to develop improved compact Si-based PBS that is wavelength insensitive across entire C-band window for the integrated Si photonics circuits.

### BRIEF SUMMARY OF THE INVENTION

The present invention relates to photonic broadband communication device. More particularly, the present invention provides a Si-based broadband polarization beams splitter. Merely by example, the present invention discloses a compact PBS with a Si multimode interference PBS with high extinction ratio between orthogonal polarizations Transverse Magnetic (TM) mode and Transverse Electric (TE) mode and low insertion loss for integration in Si photonics circuits over a broad wavelength window of 1530 nm-1560 nm, though other applications are possible.

In modern electrical interconnect systems, high-speed serial links have replaced parallel data buses, and serial link speed is rapidly increasing due to the evolution of CMOS technology. Internet bandwidth doubles almost every two years following Moore's Law. But Moore's Law is coming to an end in the next decade. Standard CMOS silicon transistors will stop scaling around 5 nm. And the internet bandwidth increasing due to process scaling will plateau. But Internet and mobile applications continuously demand a huge amount of bandwidth for transferring photo, video, music, and other multimedia files. This disclosure describes techniques and methods to improve the communication bandwidth beyond Moore's law.

In an embodiment, the present invention provides a polarization beam splitter for broadband silicon photonic system. The polarization beam splitter includes a silicon waveguide body of a thickness in rectangular shape with a width and a length between a first end plane and a second end plane. Additionally, the polarization beam splitter includes two input ports formed in the first end plane at two separate locations respectively next to two opposing length edges of the silicon waveguide body configured to generate a plurality of direct or mirror images of an input optical signal provided through at least one port of the two input ports. The plurality of direct or mirror images include a first sub-set of TE polarization mode self-images of the input optical signal and a second sun-set of TM polarization mode self-images of the input optical signal. The polarization beam splitter further includes a first output port formed in the second end plane at a bar position next to a same length edge with the at least one port of the two input ports. Furthermore, the polarization beam splitter includes a second output port formed in the second end plane at a cross position next to opposing length edge of the silicon waveguide body. The cross position is separated by a distance from the bar position. In an embodiment, the width of the silicon waveguide body is selected to be 2.6 μm and accordingly the length is selected to be 40 μm to make the second end plane to be a common plane holding both a first self-image of TE polarization mode coupled to the first output port and a second self-image of TM polarization mode coupled to the second output port.

In an alternative embodiment, the present invention provides a method of manufacturing a compact polarization beam splitter for entire C-band wavelengths. The method includes providing a silicon-on-insulator substrate having a silicon layer of 220 nm on an insulator layer. Additionally, the method includes patterning the silicon layer to form a waveguide body in rectangular shape having a width of about 2.6 μm and a length of about 40 μm between a first cross plane and a second cross plane. The method further includes forming a first taper section and a second taper section with their wider ends connected respectively to a first portion and a second portion separately in the first cross plane respectively next to a first length edge and a second length edge of the waveguide body. The first length edge opposes to the second length edge. Furthermore, the method includes forming a third taper section and a fourth taper section with their wider ends connected respectively to a first portion and a second portion separately in the second cross plane respectively next to the first length edge and the second length edge of the waveguide body. The method further includes forming a first input waveguide and a second input waveguide respectively connected to two narrower ends of the first and the second taper sections. The first input waveguide is configured to receive an input optical wave while the second input waveguide is terminated. Moreover, the method includes forming a first output waveguide and a second output waveguide respectively connected to two narrower ends of the third and the fourth taper sections. The first output waveguide is configured for outputting a first output optical wave primarily in TE polarization mode. The second output waveguide is configured for outputting a second output optical wave primarily in TM polarization mode.

In another alternative embodiment, the present invention provides a method of manufacturing a compact polarization beam splitter for entire C-band wavelength window. The method includes.

In a specific embodiment, the present invention provides a silicon photonics integration system for data center and short reach network comprising a polarization beam splitter for splitting a non-polarized optical signal to a TE mode signal and a TM mode signal. The polarization beam splitter includes a silicon waveguide body of a thickness in rectangular shape with a width and a length between a first end plane and a second end plane. The polarization beam splitter also includes two input ports formed in the first end plane at two separate locations respectively next to two opposing length edges of the silicon waveguide body configured to generate a plurality of direct or mirror images of an input optical signal provided through at least one port of the two input ports. The plurality of direct or mirror images include a first sub-set of TE polarization mode self-images of the input optical signal and a second sun-set of TM polarization mode self-images of the input optical signal. The polarization beam splitter further includes a first output port formed in the second end plane at a bar position next to a same length edge with the at least one port of the two input ports and a second output port formed in the second end plane at a cross position next to opposing length edge of the silicon waveguide body, the cross position being separated by a distance from the bar position. The width of the silicon waveguide body is selected to be 2.6 μm and accordingly the length is selected to be 40 μm to make the second end plane to be a common plane holding both a direct self-image of TE polarization mode coupled to the first output port and a mirror self-image of TM polarization mode coupled to the second output port.

Many benefits of polarization beam splitting can be achieved with the present invention based on the silicon waveguide MMI coupler. As an example, using silicon material only is fully compatible with CMOS technology based on standard SOI wafer with 200 nm Si-layer, which substantially simplifies the waveguide process and enhances production yield with high process tolerance. Due to large Si birefringence general interference with edge mode excitation in the MMI coupler is utilized and optimized in waveguide width and length design for achieve high extinction ratio (ER) between polarization TE mode and TM mode. The TE mode is outputted as a direct image while TM mode is outputted as a mirror image in a compact MMI size of 2.6×40 μm. Additionally, the benefit lies in both its wavelength insensitive (over entire C-band) characteristics and temperature insensitive characteristics.

The present invention achieves these benefits and others in the context of known polarization beam splitting technology. However, a further understanding of the nature and advantages of the present invention may be realized by reference to the latter portions of the specification and attached drawings.

### BRIEF DESCRIPTION OF THE DRAWINGS

The following diagrams are merely examples, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

FIG. 1 is a simplified diagram of a general interference MMI waveguide-based polarization beam splitter according to an embodiment of the present invention.

FIGS. 2A and 2B are an exemplary diagram of optical intensity distribution of (A) TE mode and (B) TM mode through the MMI PBS of FIG. 1 according to an embodiment of the present invention.

FIG. 3 is an exemplary plot of normalized transmission loss measured respectively for TE mode and TM mode through the MMI PBS of FIG. 1 over C-band wavelengths according to an embodiment of the present invention.

FIG. 4 is an exemplary plot of extinction ratio (ER) for TE and TM mode measured on the MMI PBS of FIG. 1 over C-band wavelengths according to an embodiment of the present invention.

FIG. 5 is an exemplary plot of insertion loss for TE-Bar signal and TM_X signal passing the MMI PBS of FIG. 1 over C-band wavelengths at various operation temperatures according to an embodiment of the present invention.

FIG. 6 is an exemplary plot of extinction ratio for TE and TM mode on the MMI PBS of FIG. 1 over C-band wavelengths at various operation temperatures according to an embodiment of the present invention.

### DETAILED DESCRIPTION OF THE INVENTION

The present invention relates to photonic broadband communication device. More particularly, the present invention provides a Si-based broadband polarization beams splitter. Merely by example, the present invention discloses a compact PBS with a Si multimode interference PBS with high extinction ratio between orthogonal polarizations Transverse Magnetic (TM) mode and Transverse Electric (TE) mode and low insertion loss for integration in Si photonics circuits over a broad wavelength window of 1530 nm-1560 nm, though other applications are possible.

Integrated polarization beam splitter (PBS) is a key element for polarization management in next polarization-independent silicon photonics circuit for applications in coherent optical communication systems, sensing, optical signal processing, planar lightwave circuits (PLC), and other areas. Compact, simple and broadband PBS on widely supplied standard silicon-on-insulator (SOI) wafer with 220 nm Si layer is crucial for polarization-independent Dense Wavelength Division Multiplexing (DWDM) communication in the C-band window. In principle, waveguide-based polarization splitting is achieved by utilizing the modal birefringence inherent in optical waveguides. In the following sections, multi-mode interferometer (MMI) based polarization beam splitter (PBS) with general interference working mode is explored by utilizing birefringence of silicon material only. Particularly, the Si MMI PBS is expected to be formed with high extinction ratio of 22 dB or greater and operable in entire C-band from 1530 nm to 1560 nm.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

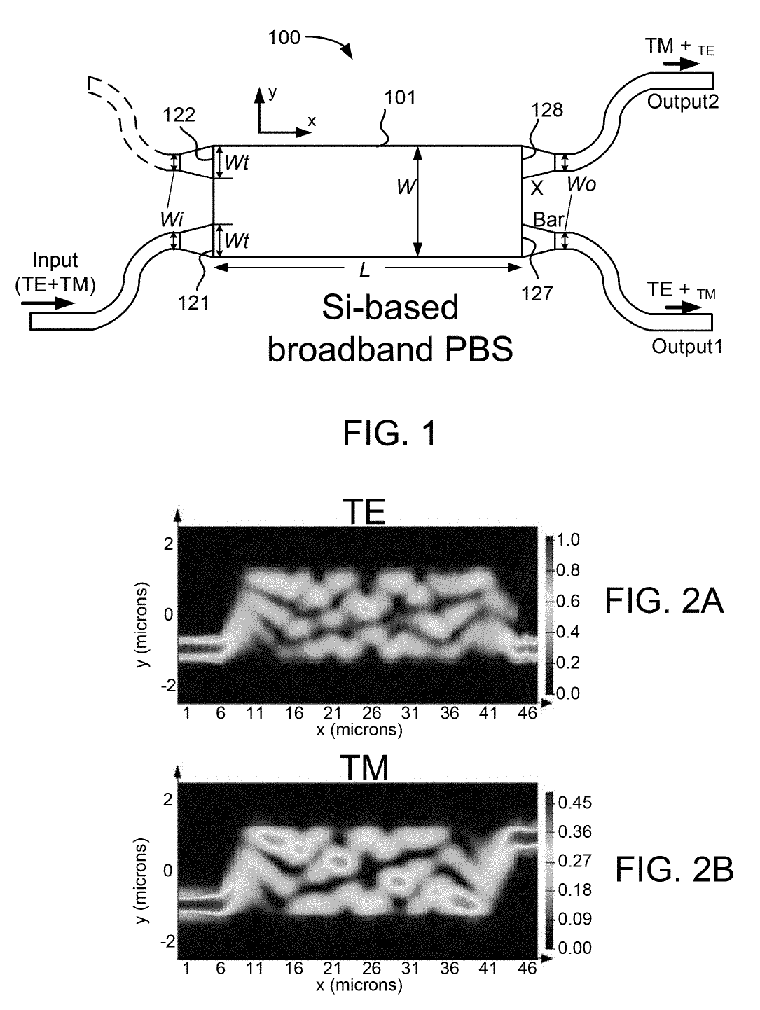

FIG. 1 is a simplified diagram of a general interference MMI waveguide-based polarization beam splitter according to an embodiment of the present invention. This diagram is merely an example, which should not unduly limit the scope of the claims. One of ordinary skill in the art would recognize many variations, alternatives, and modifications. As shown, a Si MMI device 100 is formed as a planar waveguide of a certain thickness in a rectangular body of a width W and a length L from a first end plane to a second end plane. The planar waveguide is configured, upon receiving an optical signal non-polarized with mixed TE and TM mode from an input port in the first end plane next to a length edge, to work in a general interference mode to excite multiple direct or mirror images for both TE and TM modes at various cross-section planes at various distances from the first end plane. Because the index change from a first order TE mode to zero order TE mode is different from the index change from a first order TM mode to zero order TM mode, each direct or mirror image of TE mode may be located at a different plane from that the image of TM mode is located. The direct or mirror images for TE mode and TM mode are repeated with different periods along the length L. Yet, the length L of the planar rectangular waveguide, in associated with the width W at the certain thickness, is selected to be a minimum value for making the second end plane of the waveguide body 101 to be substantially a common plane for a TE mode image and a TM mode image as well. In an embodiment, a direct image of TE mode signal is outputted at a bar port in the second end plane and a mirror image of TM mode signal is outputted at a cross (X) port in the second end plane. The so-called bar port is referred to a position in the second end plane next to the same length edge for the input port. The X port is thus referred to another position in the second end plane next to an opposing length edge of the waveguide body. Thus, the MMI device 100 is a MMI-based polarization beam splitter (PBS).

In an embodiment, in compatible with the general interference working mode, two input ports 121 and 122 are positioned at two separate portions of the first end plane respectively next to two opposing length edges of the rectangular waveguide body 101. One of the two input ports, e.g., input port 121, is used as true input port while leaving another input port 122 as a dummy port. Essentially, the MMI PBS 100 is a 2×2 MMI device. Each input port 121 (or 122) includes a taper section having one end having a wider width Wt connected to the first end plane and another end of a narrower width Wi connected to an extended Si wire waveguide for guiding optical wave into the MMI device. Similarly, two output ports 127 and 128 are positioned to respective two separate portions of the second end plane, one in bar position and another in X position, in compatible with the general interference working mode. Both output ports 127 and 128 also include taper sections having wider ends connected to the second end plane similar in shape and dimensions to those associated with two input ports and narrower ends connected to respective two extended wire waveguides, outputl and output2. One output port 127 at the bar-position outputs a first output signal primarily in TE mode including a substantially small powered TM mode with an extinction ratio TM_ER. The first output signal is further guided into the wire waveguide output1. Another output port 128 at X-position outputs a second output signal primarily in TM mode including a substantially small powered TE mode with an extinction ratio TE_ER. The second output signal is further guided into the wire waveguide output2.

In a specific embodiment, the first output signal is substantially a direct self-image of the input TE mode and the second output signal is substantially a mirror self-image of the input TM mode. Aiming to obtain a smallest width/length dimension for the MMI PBS to split a non-polarized input optical signal to self-images of the TE mode and TM mode at separate output ports in a common plane, the width W is preferred to be 2.6 μm and the length L is preferred to be 40 μm for a planar Si waveguide with a height of 200 nm formed directly in the 220 nm Si layer of the standard SOI substrate. The above dimension of W or L can be controlled as small as ±30 nm for state-of-art Si waveguide processing technique performed on the standard SOI substrate, although larger process tolerance e.g., 5% in dimension variation, is acceptable. In addition, the taper section on the first end plane (input) or the second end plane (output) has a width of 0.7 μm and a smaller end of width 0.45 μm for the extended Si waveguide section. Thus, there is a separation of about 1.2 mm existed between the two taper sections on the first (second) end plane.

A combination of the above preferred dimensions of the Si-based MMI device and waveguide with an intrinsic optical index of Si material provides an optimum excitation pattern of the general interference of an optical signal having either TE or TM polarization mode within the rectangular MMI body 101 and ensures that, upon receiving an input of mixed TE/TM mode signal at the input port 121, the bar output port 127 outputs a TE mode signal with high extinction ratio for TM mode and the cross output port 128 outputs a TM mode signal with high extinction ratio for TE mode.

FIGS. 2A and 2B are an exemplary diagram of optical intensity distribution of (A) TE mode and (B) TM mode through the MMI PBS of FIG. 1 according to an embodiment of the present invention. In part (A), it is only shown that TE mode intensity of an optical wave inputted from the lower left corner is excited within the rectangular waveguide body 101. The intensity of the optical wave is distributed as a plurality of local peaks representing either direct or mirror images of the input TE mode in multiple planes across the width Win y-direction located at different distances from the input plane through the whole length L along x-direction of the waveguide body 101 (see FIG. 1). The TE mode signal finally is outputted primarily at the lower right corner. In part (B), it is only shown that TM mode intensity of an optical wave inputted from the lower left corner is excited within the rectangular waveguide body 101. The intensity of the optical wave is distributed as a plurality of local peaks representing either direct or mirror images of the input TM mode in multiple alternative planes across the width Win y-direction located at alternative different distances from the input plane through the whole length L along x-direction of the waveguide body 101 (see FIG. 1). The TM mode signal finally is outputted primarily at the upper right corner. Of course, for a non-polarized optical signal with mixed TE and TM modes inputted from the input port at lower left corner, both TE and TM modes will be excited within the MMI body 101 respectively shown in part (A) and part (B) of FIG. 2. The MMI PBS 100 of the present disclosure can be processed with a standard SOI wafer with a fixed 220 nm thick Si layer, based on which its width and length can be optimized such that the bar output port at lower left corner substantially outputs only TE mode signal and the cross output port at upper left corner substantially outputs only TM mode signal, to achieve polarization splitting to the non-polarized input optical signal. An optimized MMI PBS has a small ultra compact width W of about 2.6 μm and an associated length L of about 40 μm based on the 220 nm Si layer from the standard SOI wafer. This is much tighter in dimensions than conventional (2×2 MMI+MZI)-based PBS which typically has a length >100 μm and 400 nm or greater in thickness. It also much shorter than some SiN-based waveguide PBS devices which are typically at a scale of 100 μm and often need to be cascaded to an even longer length for achieving higher TE/TM extinction ratio.

In an alternative embodiment, the present disclosure provides a method for manufacturing a compact polarization beam splitter based on Si waveguide for entire C-band wavelengths. In the method, a silicon-on-insulator (SOI) substrate is used for forming a waveguide that is configured to be a polarization beam splitter (PBS). The SOI substrate is a standard one having a silicon layer of 220 nm in thickness formed on a thick insulator layer. The 220 nm thick Si layer is used to form the planar waveguide with a common height used for the PBS as well as its associated input and output wire waveguide. In particular, this height is much smaller than most state-of-art multimode interference coupler waveguides formed by alternative method.

In addition, the method includes patterning the Si layer of the standard SOI substrate directly to form a waveguide body in rectangular shape with an optimized dimension having a width of about 2.6 μm and a length of about 40 μm between a first cross plane and a second cross plane.

Further, the method includes forming a first taper section and a second taper section with their wider ends connected respectively to a first portion and a second portion separated from each other in the first cross plane respectively next to a first length edge and a second length edge of the waveguide body. The first length edge is opposed to the second length edge.

Further, the method includes forming a third taper section and a fourth taper section with their wider ends connected respectively to a first portion and a second portion separated from each other in the second cross plane respectively next to the first length edge and the second length edge of the waveguide body.

Furthermore, the method includes forming a first input waveguide and a second input waveguide respectively connected to two narrower ends of the first taper section and the second taper section. The first input waveguide is a wire waveguide with a narrow width of about 0.45 μm configured to receive and guide an input optical wave while the second input waveguide is also a similar wire waveguide. The second input waveguide is terminated for any optical signal for the PBS.

Moreover, the method includes forming a first output waveguide and a second output waveguide respectively connected to two narrower ends of the third taper section and the fourth taper section. The first output waveguide is a wire waveguide with a narrow width of about 0.45 μm configured for outputting a first output optical wave primarily in TE polarization mode. The second output waveguide is configured to be substantially similar wire waveguide for outputting a second output optical wave primarily in TM polarization mode.

In a specific embodiment, patterning the Si layer to form a waveguide body and forming each of the first, second, third, and fourth taper section and forming each of the first and second input waveguides and the first and second output waveguides comprise patterning the same Si layer of 220 nm thickness of the SOI substrate in a single process. The width of wider end of each taper section is ˜0.7 μm and 1.2 μm distance apart from the neighboring taper section in the same (first or second) end plane.

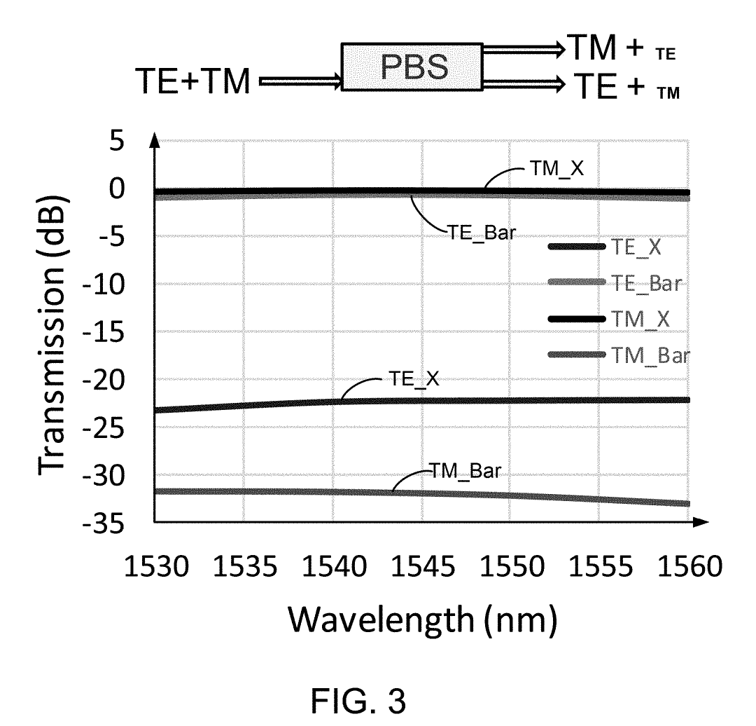

FIG. 3 is an exemplary plot of normalized transmission loss measured respectively for TE mode and TM mode through the MMI PBS of FIG. 1 over C-band wavelengths according to an embodiment of the present invention. This diagram is merely an example, which should not unduly limit the scope of the claims. One of ordinary skill in the art would recognize many variations, alternatives, and modifications. As shown, transmission loss measured for a TE mode signal and a TM mode signal passing the MMI PBS 100 (see FIG. 1) are plotted against entire C-band from 1530 nm to 1560 nm. The TE mode signal is inputted, as shown in an experimental setup in upper part of FIG. 3, from the first input port 121 with power P_{TEin} (assuming no TM mode is inputted). At both the bar output port 127 and cross output port 128, the TE mode signal is also independently measured as P_{TE}_{_}_{Bar} and P_{TE}_{_}_{X}, for all wavelengths in the C-band window. Then, the transmission loss for TE mode signal outputted at bar output port is represented by 10 log₁₀(P_{TE}_{_}_{Bar}/P_{TEin}) and plotted into the second curve (counted from top) in the figure. It shows that the transmission loss at the bar output port for TE mode is quite small, almost within 1 dB for entire C-band. The transmission loss for TE mode signal outputted at cross output port is represented by 10 log₁₀(P_{TE}_{_}_{X}/P_{TEin}) and plotted into the third curve (counted from top) in the figure. But the transmission loss at the cross output port for TE mode is quite large (>22 dB). This indicates that the TE mode signal from the input port is substantially coupled to the bar output port without much loss but not outputted to the cross output port. Similarly under the same experimental setup, when a TM mode signal is inputted into the input port 121 (assuming no TE mode is inputted) and measured at both the bar output port 127 and the cross output port 128, the results show that the transmission loss for TM mode is quite high at about 31 dB or higher at the bar output port but very low at about 1 dB or lower at the cross output port over entire C-band wavelength range. This indicates that the TM mode signal from the input port is substantially coupled to the cross output port but prohibited to the bar output port. If a non-polarized optical signal is inputted to the input port, the MMI PBS as disclosed in FIG. 1 of the present invention is able to split the input optical signal into a TE mode signal outputted at the bar output port and a TM mode signal outputted at the cross output port. Only a tiny bit of TE mode power leaked to the cross output port and only a tiny bit of TM mode power is leaked to the bar output port over entire C-band. Therefore, the MMI PBS of FIG. 1 performs nicely as a broadband polarization beam splitter. The Si-based waveguide format of the MMI PBS also serves a strong base for this PBS to be integrated into a silicon photonics integration system for building modern large-scale data center and applying into short reach networks utilizing polarization-independent optical signals.

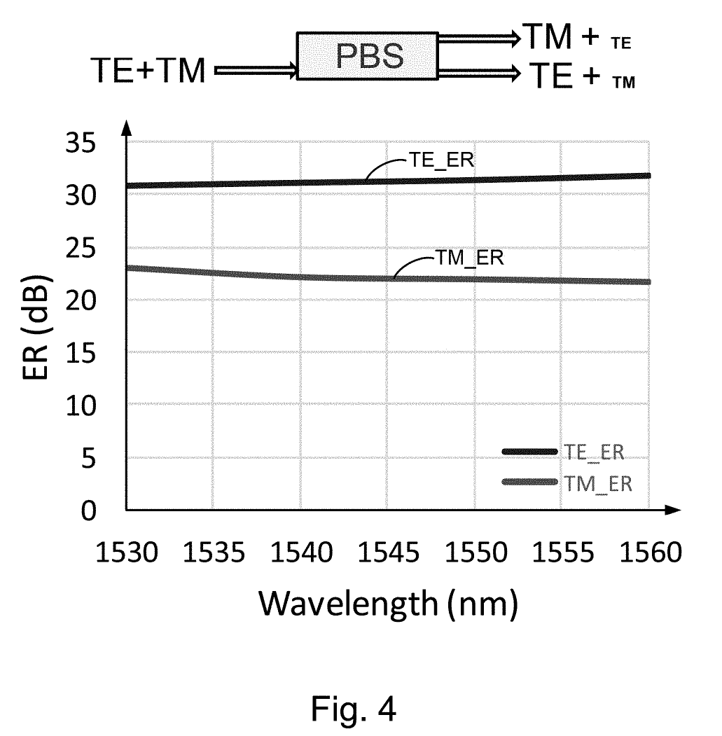

FIG. 4 is an exemplary plot of extinction ratio (ER) for TE and TM mode measured on the MMI PBS of FIG. 1 over C-band wavelengths according to an embodiment of the present invention. This diagram is merely an example, which should not unduly limit the scope of the claims. One of ordinary skill in the art would recognize many variations, alternatives, and modifications. Under a similar experimental setup based on the MMI PBS of FIG. 1, the extinction ratio, defined as 10 log₁₀ (P_{TE}/P_{TM}) of TE mode versus TM mode at either the bar output port or the cross output port can be measured. Particularly the extinction ratio TE_ER for bar output port is the power ratio of TE mode over TM mode 10 log₁₀ (P_{TE} /P_{TM}) at the bar output port and the extinction ratio TM_ER for the cross output port is the power ratio of TM mode over TE mode 10 log₁₀ (P_{TM} /P_{TE}) at the cross output port. As shown, TE_ER is greater than 31 dB and TM_ER is at least greater than 22 dB. In other words, as an input light bearing both TE and TM polarization modes passes through the MMI PBS 100, substantial splitting of the TE and TM modes occurs with primarily TE mode portion being outputted to the bar output port and TM mode portion being outputted to the cross output ports. Higher extinction ratio value indicates better polarization splitting performance.

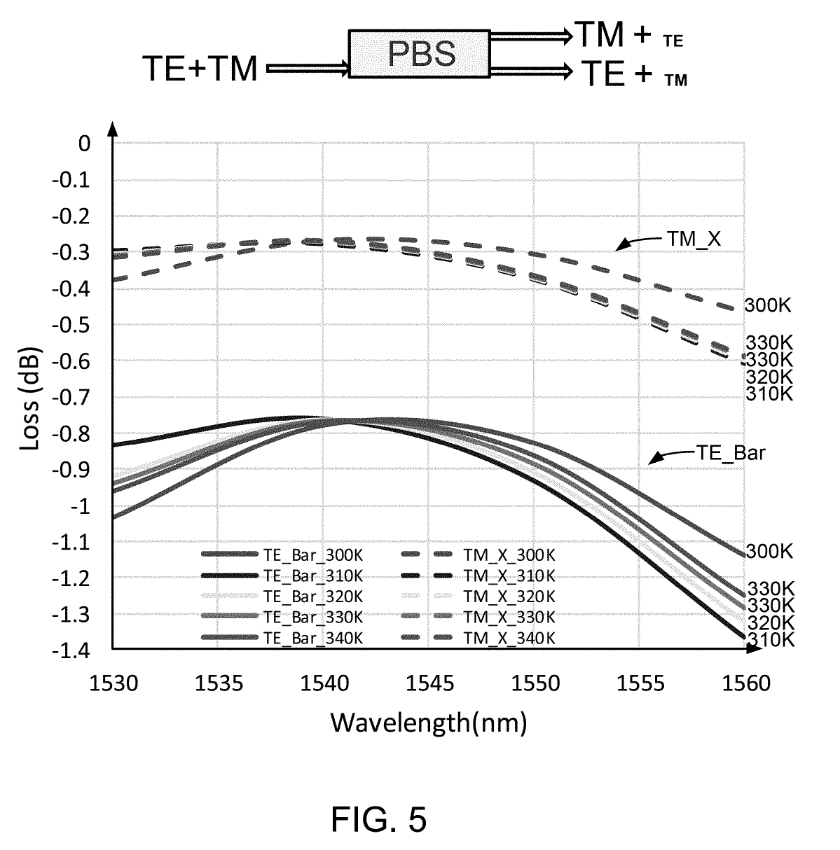

In an embodiment, polarization splitting performance of the Si-waveguide-based broadband MMI PBS provided in the present disclosure also is characterized by its temperature insensitivity over at least a range from 300 K to 340K over the same C-band wavelength window. FIG. 5 is an exemplary plot of insertion loss for TE-Bar signal and TM_X signal passing the MMI PBS of FIG. 1 over C-band wavelengths at various operation temperatures according to an embodiment of the present invention. Under the same experimental setup shown in an upper insert of the figure, the insertion loss of primary TE mode signal at the bar output port is measured as the MMI PBS is operated at various temperatures over entire C-band wavelengths and plotted as those solid curves. Similarly, the insertion loss of primary TM mode signal at the cross output port is also measured and plotted as those dashed curves. As shown, the insertion loss variation is basically smaller than 0.3 dB for the TE mode signal over a temperature change from 300K to 340K and even smaller (about 0.15 dB) for the TM mode signal over the same range of temperature change. It indicates that the polarization splitting performance of the MIMI PBS of the present disclosure is quite robust to adapt environmental temperature change, which is a great advantage for the compact waveguide-based PBS being integrated into a silicon photonics integration system for many applications such as high-rate data communication in data center or short-reach network.

Additionally, the temperature insensitivity of polarization splitting performance of the

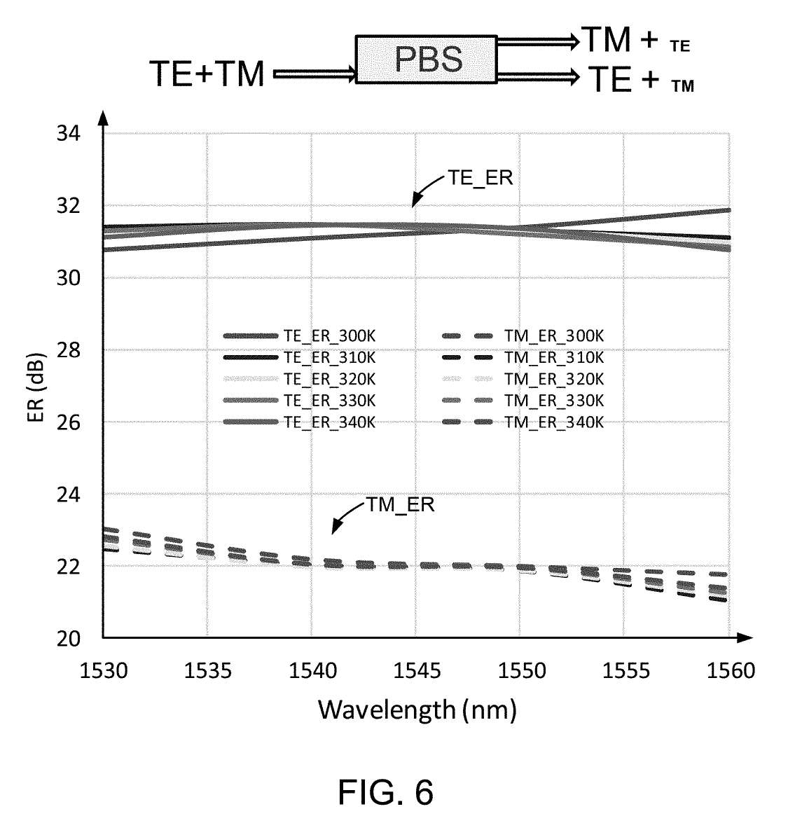

MMI PBS is also shown in terms of TE/TM extinction ratio. FIG. 6 is an exemplary plot of extinction ratio for TE and TM mode on the MMI PBS of FIG. 1 over C-band wavelengths at various operation temperatures according to an embodiment of the present invention. As shown, under the same experimental setup and the same temperature change range from 300K to 340K, the extinction ratio TE_ER for TE mode at the cross output port power is measured and plotted against C-band wavelengths as solid curves, and TM_ER for TM mode at the bar output port is also measured and plotted against C-band wavelengths as dashed curves. TE-ER only varies about 1 dB over the 40K temperature change. TM_ER is even more stable over the same range of temperature change over a broad wavelength range of 1530 nm or 1560 nm.

Accordingly, the present invention provides, inter alia, a waveguide-based polarization beam splitter (PBS), a method for manufacturing the same PBS using a standard SOI substrate with 220 nm Si layer, and a polarization-independent silicon photonics integration system that substantially obviate one or more of the problems due to limitations and disadvantages of the related art. The silicon photonics integration system comprising the waveguide-based PBS provided in this disclosure can be applied for high-rate data communication in data center and short-reach network to utilize the PBS for splitting a non-polarized optical signal to a TE mode signal and a TM mode signal. Bearing the advantage of ultra-compact size and monolithic Si waveguide processing, the MMI PBS of the present disclosure can be well suited for being integrated with various silicon photonics modules for building the silicon photonics integration system utilizing polarization-independent optical signals in entire C-band wavelengths for high-speed data communication. Optionally, the same design principle for making the MMI PBS for C-band of the present disclosure can be expanded to make a MMI PBS for O-band or other wavelength range. Optionally, multiple MMI PBS devices can be cascaded for achieving higher extinction ratio with moderate insertion loss increase for certain wavelength ranges.

While the above is a full description of the specific embodiments, various modifications, alternative constructions and equivalents may be used. Therefore, the above description and illustrations should not be taken as limiting the scope of the present invention which is defined by the appended claims.

1-3. (canceled)

4. The polarization beam splitter of claim 8, wherein each input/output port comprises a waveguide section in a taper shape having one end with a wider width attached to the first/second end plane next to one length edge and an opposing end with a shorter width connected to a separate silicon waveguide in a wire shape.

5. The polarization beam splitter of claim 4, wherein the wider width is about 0.7 μm or smaller and the shorter width is about 0.45 μm.

6. The polarization beam splitter of claim 8, wherein one of the two input ports that is not the at least one port of the two input ports is terminated optically.

7. (canceled)

8. A polarization beam splitter for a broadband silicon photonic system comprising:
a silicon waveguide body of a thickness in a rectangular shape with a width and a length between a first end plane and a second end plane, wherein the silicon waveguide body is formed by directly patterning a silicon layer of a silicon-on-insulator (SOI) substrate, wherein the thickness of the silicon waveguide body is substantially equal to 220 nm of the silicon;
two input ports formed in the first end plane at two separate locations respectively next to two opposing length edges of the silicon waveguide body configured to generate by a general interference working mode, a plurality of direct or mirror images of an input optical signal provided through at least one port of the two input ports, the plurality of direct or mirror images comprising a first sub-set of a TE polarization mode self-images of the input optical signal and a second sub-set of a TM polarization mode self-images of the input optical signal;
a first output port formed in the second end plane at a bar position next to a same length edge with the at least one port of the two input ports; and
a second output port formed in the second end plane at a cross position next to the opposing length edge of the silicon waveguide body, the cross position being separated by a distance from the bar position, wherein:
the width is selected to be 2.6 μm and accordingly the length is selected to be 40 μm to make the second end plane to be a common plane holding both a first self-image of TE polarization mode coupled to the first output port and a second self-image of TM polarization mode coupled to the second output port,
the first output port outputs a first output signal as a direct image primarily in the TE polarization mode with a transmission loss less than 1.4 dB over a wavelength window of 1530 nmto 1560 nm, and
the first output signal comprises substantially small amount of the TM polarization mode characterized by a TE/TM extinction ratio of 32 dB or greater at the first output port.

9. The polarization beam splitter of claim 8, wherein the first output signal primarily in the TE polarization mode is characterized by temperature insensitivity of less than 0.4 dB variation in the transmission loss for a temperature range from 300K to 340K over the wavelength window of 1530 nmto 1560 nm.

10. The polarization beam splitter of claim 8, wherein the first output signal primarily in the TE polarization mode is characterized by temperature insensitivity of less than 1 dB variation in the TE/TM extinction ratio for a temperature range from 300K to 340K over the wavelength window of 1530 nmto 1560 nm.

11. The polarization beam splitter of claim 8, wherein the second output port outputs a second output signal as a mirror image primarily in the TM polarization mode with a transmission loss less than 0.6 dB over a wavelength window of 1530 nm to 1560 nm.

12. The polarization beam splitter of claim 11, wherein the second output signal comprises substantially small amount of the TE polarization mode characterized by a TM/TE extinction ratio of 22 dB or greater at the second output port.

13. The polarization beam splitter of claim 11, wherein the second output signal primarily in the TM polarization mode is characterized by temperature insensitivity of less than 0.2 dB variation in the transmission loss for a temperature range from 300K to 340K over the wavelength window of 1530 nmto 1560 nm.

14. The polarization beam splitter of claim 12, wherein the second output signal primarily in the TM polarization mode is characterized by temperature insensitivity of less than 1 dB variation in the TM/TE extinction ratio for a temperature range from 300K to 340K over the wavelength window of 1530 nmto 1560 nm.

15. A method of manufacturing a compact polarization beam splitter for entire C-band wavelengths, the method comprising:
providing a silicon-on-insulator substrate having a silicon layer of 220 nm on an insulator layer;
patterning the silicon layer to form a waveguide body in a rectangular shape having a width of about 2.6 μm and a length of about 40 μm between a first cross plane and a second cross plane;
forming a first taper section and a second taper section with their wider ends connected respectively to a first portion and a second portion separately in the first cross plane respectively next to a first length edge and a second length edge of the waveguide body, the first length edge opposing to the second length edge;
forming a third taper section and a fourth taper section with their wider ends connected respectively to a first portion and second portion separately in the second cross plane respectively next to the first length edge and the second length edge of the waveguide body;
forming a first input waveguide and a second input waveguide respectively connected to two narrower ends of the first and the second taper sections, the first input waveguide being configured to receive an input optical wave while the second input waveguide being terminated; and
forming a first output waveguide and a second output waveguide respectively connected to two narrower ends of the third and the fourth taper sections, the first output waveguide being configured for outputting a first output optical wave primarily in a TE polarization mode, the second output waveguide being configured for outputting a second output optical wave primarily in a TM polarization mode, wherein:
the first output waveguide outputs a first output optical wave as a direct image primarily in the TE polarization mode with a transmission loss less than 1.4 dB over a wavelength window of 1530 nmto 1560 nm, and
the first output optical wave comprises substantially small amount of the TM polarization mode characterized by a TE/TM extinction ratio of 32 dB or greater at the first output port.

16. The method of claim 15, wherein patterning the silicon layer to form a waveguide body and forming each of the first, second, third, and fourth taper section and forming each of the first and second input waveguides and the first and second output waveguides comprise patterning the same silicon layer of 220 nm of the silicon-on-insulator (SOI) substrate in a single process, the wider end of each taper section having a width selected to be about 0.7 μm and the narrower end of each taper section having a width selected to be about 0.45 μm.

17. A silicon photonics integration system for a data center and a short reach network comprising a polarization beam splitter for splitting a non-polarized optical signal to a TE mode signal and a TM mode signal, the polarization beam splitter comprising:
a silicon waveguide body of a thickness in a rectangular shape with a width and a length between a first end plane and a second end plane, wherein the silicon waveguide body is formed by directly patterning a silicon layer of a silicon-on-insulator (SOI) substrate, and wherein the thickness of the silicon waveguide body is substantially equal to 220 nm of the silicon layer;
two input ports formed in the first end plane at two separate locations respectively next to two opposing length edges of the silicon waveguide body configured to generate by general interference working mode, a plurality of direct or mirror images of an input optical signal provided through at least one port of the two input ports, the plurality of direct or mirror images comprising a first sub-set of a TE polarization mode self-images of the input optical signal and a second sub-set of a TM polarization mode self-images of the input optical signal;
a first output port formed in the second end plane at a bar position next to a same length edge with the at least one port of the two input ports; and
a second output port formed in the second end plane at a cross position next to the opposing length edge of the silicon waveguide body, the cross position being separated by a distance from the bar position;
wherein:
the width is selected to be 2.6 μm and accordingly the length is selected to be 40 μm to make the second end plane to be a common plane holding both a direct self-image of TE polarization mode coupled to the first output port and a mirror self-image of TM polarization mode coupled to the second output port,
the first output port outputs a first output signal as a direct image primarily in the TE polarization mode with a transmission loss less than 1.4 dB over a wavelength window of 1530 nmto 1560 nm, and
the first output signal comprises substantially small amount of the TM polarization mode characterized by a TE/TM extinction ratio of 32 dB or greater at the first output port.

18-19. (canceled)

20. The silicon photonics integration system of claim 17, wherein each input/output port comprises a waveguide section in a taper shape having one end with a wider width of about 0.7 μm attached to the first/second end plane next to one length edge and an opposing end with a shorter width of about 0.45 μm connected to a separate silicon waveguide in a wire shape.
